(19) United States
(12) Patent Application Publication
(10) Pub. No.: US 2024/0411300 A1
(43) Pub. Date: Dec. 12, 2024

(54) Method and System for Improving a Production Process in a Technical Installation

(71) Applicant: Siemens Aktiengesellschaft, Muenchen (DE)

(72) Inventor: Ferdinand KISSLINGER, Hersbruck (DE)

(21) Appl. No.: 18/691,726

(22) PCT Filed: Sep. 15, 2022
(86) PCT No.: PCT/EP2022/075649

§ 371 Date: Mar. 13, 2024

(30) Foreign Application Priority Data
Sep. 16, 2021 (EP) 21197160

(51) Int. Cl. G05B 23/02; G05B 19/418

(52) U.S. Cl. CPC G05B 23/024; G05B 19/41875; G05B 2219/32187

(57) ABSTRACT

A method and system for improving a production process in a technical installation in which a process-engineering process having a process is implemented, where data records, which characterize an iteration of a process step and which have values of process variables, are recorded in a time-dependent manner and stored in a data memory, and, for each process step, the data records of an iteration are selected as a test phase, and the data records of at least one further iteration are selected as a reference phase, where similarity between the data records of the test phase and at least one reference phase is subsequently determined in pairs, where a calculated phase similarity measure is used to optimize the process such that multiple applications in process optimization, such as determining a “golden batch” and a root cause analysis of faulty batches by correlating with metadata, can be performed.

### CROSS-REFERENCE TO RELATED APPLICATIONS

This is a U.S. national stage of application No. PCT/EP2022/075649 filed 15 Sep. 2022. Priority is claimed on European Application No. 21197160.1 filed 16 Sep. 2021, the content of which is incorporated herein by reference in its entirety.

### BACKGROUND OF THE INVENTION

### 1. Field of the Invention

The invention relates to a method, computer program, computer program product and system for improving a production process in a technical installation, in which a process-engineering process having at least one process step runs.

### 2. Description of the Related Art

Process engineering is concerned with the technical and efficient performance of all processes in which substances or raw material are changed in nature, property and composition. To implement such a process, process-engineering installations, such as refineries, steam crackers or other reactors, are used, in which the process-engineering process is usually realized via automation technology. Process-engineering processes are basically divided into two groups: continuous processes and discontinuous processes, known as batch processes. A complete production process, i.e., starting from particular educts through to the finished product, can also be a mixture of both process groups.

The continuous process runs without interruptions. It is a flow process, meaning that there is a constant inflow or outflow of material, energy or information. Continuous processes are preferred when processing large quantities with few product changes. One example would be a power plant that produces power, or a refinery that extracts fuels from crude oil.

Discontinuous processes are all batch processes that run in a batch-oriented operating mode, for example in accordance with ISA-88, in accordance with recipes. These recipes contain the information as to which process steps are implemented consecutively or else in parallel, in order to produce a particular product with particular quality requirements. Material or substances are frequently used at different points in time, and indeed in batches and nonlinearly in the respective subprocess. This means that the product runs through one or more reactors, where it remains until the reaction has occurred and the next production step or process step can be completed. Batch processes hence in principle basically occur step by step with at least one process step.

The process steps can therefore occur on different units (physical devices in which the process is implemented) and/or with different control strategies and/or different quantities. Use is frequently made of sequential functional controls (SFC) or of step chains.

The term “batch” is used below as an abbreviation for a batch process having at least one process step. In accordance with the ISA-88 standard a process step is the smallest unit of a process model. In the model of the sequential functional control (cf. ISA-88), what is known as a phase or function corresponds to a process step. Such phases can run consecutively (heating up of the reactor, agitation inside the reactor and cooling down of the reactor), but also in parallel to one another, such as “Agitation” and “Keep temperature constant”. A batch process generally contains multiple process steps or phases.

In an ideal batch process, it is assumed that a process step or phase, under optimal conditions in the context of a specific recipe, runs with a predefined control strategy and in a particular sub-installation or installation unit. It is further expected that each iteration of this batch phase is the same. All measurements linked to the installation additionally exhibit the same trend (time series of a sensor value), beginning with the start time of the phase to the end time of the phase. This behavior can be referred to as a “golden batch”. A golden batch thus indicates the best production state achieved to date with respect to quality, quantity, duration, and the least possible amount of waste.

In contrast, in a real batch process the operation in the process-engineering production installations is, however, influenced by a plurality of process parameters, operating parameters, production conditions, installation conditions and settings, so that an ideal process is achieved only approximately.

In a real process, the following factors for example influence the correct performance of a process step:
noise in the sensor measured values,
ambient conditions (e.g. the outside temperature),
quality of the educts,
deterioration of the equipment (e.g. blockage of a valve),
electrical failures of the equipment (e.g. valves that have lost the connection),
mechanical failures of the equipment (e.g. sudden blockage of a valve) or
variations in the quality of the pipes, resulting in a different flow rate.

Frequently there is not just one golden batch for a particular phase, but a set of golden batches. There are also certain tolerances, within which a phase or a particular operational sequence of a phase can be regarded as good. Finding the golden batch and the corresponding tolerance is hence a multivariate problem, which can be solved by analyzing multiple good iterations of a phase. This is frequently associated with a great deal of effort and is mostly determined by the expert knowledge of an operator, condition monitoring systems being used either separately or in conjunction with process control systems.

A common method of identifying problems in batch processes is to monitor the process values using alarm thresholds. If a threshold value for a particular process value is violated, then the operator of an installation is notified by the process control system. Setting these threshold values is very complex and in addition multivariate deviations cannot be identified within the univariate threshold values.

A second possibility for identifying problems in batch processes is to evaluate the laboratory measurements of the finished product. If a laboratory measurement lies outside the quality specifications, then the process engineers can check the trend data of the corresponding batch phases. Finally, it is the task of the process experts to determine the cause of a particular problem and to initiate measures to solve the problem and avoid it in future. This approach of cause determination is very cost-intensive and requires qualified and experienced process experts. A further disadvantage is that if the problem is discovered on the basis of a laboratory measurement outside the process, there is already a time delay between the phase in which the problem was discovered and the current phase of production. This means that production problems are frequently not discovered until too late and in retrospect.

### SUMMARY OF THE INVENTION

In view of the foregoing, it is hence an object of the present invention for batch processes to provide a data-based, simple method and system for improving the production process, which in particular makes it easy for a user to determine “golden batches” and on the basis thereof to offer further analyses of the production process, and which does not require any elaborate physical modeling of complex nonlinear dynamic processes. On that basis, it is a further object of the invention is to provide a suitable computer program, computer program product and graphical user interface.

There and other objects and advantages are achieved in accordance with the invention a method, a system, a computer program, a computer program product and a graphical user interface, where a data-model-based determination of a degree of similarity of iterations of batch process steps is used to obtain more detailed statements and analyses about the production process, in order thus to optimize the production process. Data-driven anomaly detection is normally used to detect deviations from the normal situation. However, in accordance with the present invention anomaly detection is used to calculate the phase similarities between the current phase iteration and historic phase iterations for process optimization.

The invention therefore relates to a method and system for improving the production process in a technical installation, in which a process-engineering process having at least one process step runs, where data records, which characterize an iteration of a process step and have values of process variables, are recorded in a time-dependent manner and stored in a data memory, and for each process step the data records of an iteration are selected as a test phase and the data records of at least one further iteration are selected as a reference phase. Subsequently, a similarity between the data records of the test phase and at least one reference phase is determined in pairs by determining anomaly states of the test phase with respect to each existing reference phase via a model, performing an evaluation of the anomaly states, and calculating a phase similarity measure via the anomaly states and the evaluations, where the phase similarity measure is used to optimize the process.

The advantages of the inventive method and system are manifold, because the determination of the phase similarity measure can be used in many different ways and can be combined. As a function of the match between a test phase and a historic reference phase, statements on the optimization of future test phases can be made using the known data of the historic reference phase. If, for example, the historic reference phase is a process step that produces a good quality of the products (for example, a synthetic material with high purity), then the control and operating parameters for this process step can be reproduced. Further, using the phase similarity a robust anomaly detection can also be performed between test and reference phases based on the deviations established.

In contrast to the simulation of a rigorous process model, the effort involved in modeling becomes superfluous. The process of training the data model used can advantageously be largely automated. If few historic data records are available, or none at all, then in principle a single reference phase is sufficient to make initial rough statements about existing anomalies. The invention is in particular suitable for batch processes. Accordingly, then invention can advantageously be used in the pharmaceutical industry in the production of medicines or vaccines.

The inventive method further has the advantage of analyzing new data from batch phases that was not used during the model training. These new data records can be data records from a phase that has already been concluded, or from a phase that is currently running. In the second case, the system compares the phases until the current relative time stamp, where the relative time stamp is always measured chronologically from the start of the phase.

In a first particularly advantageous embodiment, metadata of the reference phases is taken into account during the optimization of the process, in that a correlation is created between the phase similarity measure of the test phase and of the reference phase with the metadata of the reference phase and, based on this correlation, statements about the test phase are determined and/or a cause analysis occurs using the metadata. On the basis of the phase similarity, the inventive method offers a completely new type of cause analysis. The metadata of a historic reference phase can, for example, characterize data about the quality of a historic iteration or contain data about errors that have occurred or data about the energy consumed during the iteration. If, for example, a problem occurs a second time, this metadata provides important information for a fast cause analysis (compared to the current situation). Even if a problem occurs for the first time, via the inventive method, the most similar historic runs of the phase can be determined. A process engineer can analyze the difference (e.g., in the trend data) between these most similar historic runs and the current iteration. In this case, the concentration on a few similar historic iterations also permits a quick cause analysis.

If a particular problem occurs at least a second time, then the metadata therefore supplies important information for a faster cause analysis (compared to the current situation). But even if a problem occurs for the first time, via the inventive method the most similar historic iterations of the phase compared to a test phase can be found. A process engineer can analyze the difference (e.g., in the trend data) between these most similar historic iterations and the current iteration. If only a few similar historic iterations are taken into account, then the cause analysis can be accelerated.

Another advantage of the inventive method is that the model training does not require the metadata. Thus an inventive system can be built up completely without historic records of metadata, significantly reducing the work of system implementation in an installation. However, if metadata for the historic iterations is available, then this metadata can be used as labels for the model training, e.g., to balance the number of “good” runs (normally most runs are good) with the small number of errors or “bad” runs using standard techniques such as oversampling or sample weightings.

In a further advantageous embodiment, the anomaly states are calculated, in that for each process step for the same process variables of the test and reference phase time stamp by time stamp the size of the differences or mathematical distances of the process variables, their tolerances and/or the difference in the runtimes of the phases is determined. This is a particularly simple and robust procedure.

In a further advantageous embodiment, the anomaly states are evaluated via weightings and/or averaging and/or categories. In this way, individual influencing variables can be evaluated with regard to their importance. This advantageously means that particular anomaly states have a greater influence on the result of the phase similarity measure.

In a particularly advantageous embodiment, the evaluation of the anomaly states follows a previously defined hierarchy. In this way, a decision strategy can advantageously be implemented as to how particular deviations should be weighted. Thus, for example, the different durations of the iterations of the test and reference phases can be weighted more strongly than the fact of which value of the process variables is larger or smaller than the comparable value for each time stamp. If sensor-related deviations or uncertainties determine the iteration, then this can be weighted, compared to the various phase iterations, in accordance with the circumstances of the installation. This advantageously permits a flexible calculation of the phase similarity measure, adapted to the respective situation and installation.

In a further advantageous embodiment, similar phases are grouped based on the calculated phase similarity measures and via the metadata a cause analysis is performed for the grouping. This, for example, permits, in a first approximation, conclusions to be drawn about a systematic error or else an indication of very well adjusted operating parameters of the technical installation. If multiple similar phases are correlated with similar metadata, then initial indications of a particular behavior can be consolidated.

In a particularly advantageous embodiment of the inventive method, a ranking is performed of the phase similarity measure and the phases with the greatest match between test and reference phases are displayed on the display unit. The display can further be combined with the display of metadata of the corresponding reference phase. In this way, it is advantageously possible to trace which parameters have a particular influence on the similarity between test and reference phase.

The objects and advantages in accordance with the invention are further achieved by a system for improving the production process in a technical installation. The term “system” can refer both to a hardware system such as a computer system consisting of servers, networks and memory units, and to a software system such as a software architecture or a larger software program. A mixture of hardware and software is also conceivable, for example, an IT infrastructure such as a cloud structure with its services. Components of such an infrastructure usually include servers, memories, networks, databases, software applications and services, data directories and data management. In particular, virtual servers likewise form part of a system such as this.

The inventive system can also be part of a computer system which is spatially separate from the location of the technical installation. The connected external system then advantageously has the evaluation unit, which can access the components of the technical installation and/or the data memory connected thereto, and which is configured to visualize the calculated results and to transfer them to a display unit. In this way, for example, a coupling can be made to a cloud infrastructure, which further increases the flexibility of the overall solution.

Local implementations on computer systems of the technical installation may also be advantageous. Thus, an implementation, for example, on a server of the process control system or on-premise, i.e., inside a technical installation, is especially suitable in particular for safety-related processes.

The inventive method is thus preferably implemented in software or in a software/hardware combination, so that the invention also relates to a computer program with program code instructions executable by a computer for the implementation of the diagnostic procedure. In this connection, the invention also relates to a computer program product, in particular a data carrier or a storage medium, containing such a computer program that can be executed by a computer. As described above, such a computer program can be loaded into a memory of a server of a process control system so that the monitoring of the operation of the technical installation is performed automatically, or in the case of cloud-based monitoring of a technical installation, the computer program can be stored in a memory of a remote service computer or loaded into it.

The objects and advantages in accordance with the invention are correspondingly achieved by a graphical user interface (GUI), which is displayed on a display unit, and which is configured to display the results of the inventive system in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described and explained in greater detail below using the figures and using an exemplary embodiment, in which:

FIG. 1 shows a comparison of graphical plots of multivariant time series data from two iterations of a batch process step in accordance with the invention;

FIG. 2 shows a schematic representation to clarify the calculation of the anomaly states using individual categories for the time stamps of the test and reference phase;

FIG. 3 shows an example of a system in which the inventive method is performed; and

FIG. 4 is a flowchart of the method in accordance with the invention.

### DETAILED DESCRIPTION OF THE EXEMPLARY EMBODIMENTS

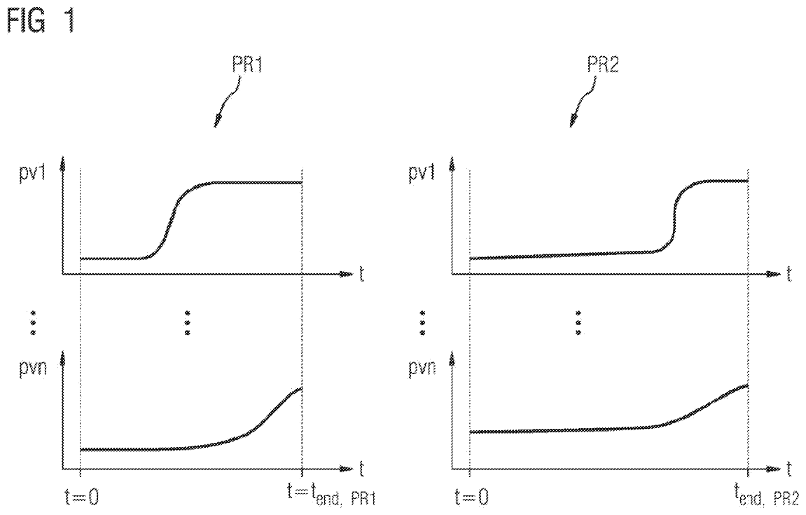

In a simplified and schematic manner, FIG. 1 shows graphs with multivariant time series data of a batch process step for two iterations. Shown on the left are the trends or time series of different process variables pv for a first iteration PR1 of a process step or a phase. Shown on the right are the trends or time series of the same process variables pv for a second iteration PR2 of the same process step or phase. The term “time series” assumes that data does not occur continuously, but rather discretely (at specific time stamps), but at finite time intervals. In order to monitor the operation of a process-engineering installation, a plurality of data records of process variables pv, which characterize the operation of the installation, are captured as a function of the time t and are stored in a data memory (frequently an archive). “Time-dependent” here consequently means either at particular individual time points with time stamps or with a sampling frequency at regular intervals or else approximately continuously. The data records of the first iteration PR1 thus contain n process variables pv with the respective time stamps, where n represents any natural number. Process variables are generally captured via sensors. Examples of process variables are temperature T, pressure P, flow rate F, level L, density or gas concentration of a medium. For each individual process variable, such as the process variables pv1, the following applies: pv1(t)=(pv1 (t1), pv1(t2), pv1(t3) . . . pv1(tN))^{T}, where N represents any natural number and corresponds to the number of the time stamps of a process step. The start time of each process step or phase is designated by t=0 and the end time or the time stamp at which the process step or the phase ends is designated by t=tend. Units of the axes of the graphs are left out of consideration, here.

In FIG. 1, it can clearly be seen, when comparing the multivariant data of both the iterations PR1 and PR2, that there are differences in the time series of the individual process variables: iteration PR2 lasts significantly longer: tend,PR1<tend, PR2. The trend profiles of the individual process variables also differ. Process variable pv1 of the second phase iteration PR2 increases later than in the first phase iteration. It should be noted that deviations can occur in the trend data of the process variables of one iteration compared to the other iteration, even if both phase iterations can be classified as “good”. Not shown here are statistical fluctuations when recording the measured values for the process variables caused by the measuring technology of the sensors.

The inventive method is explained in detail below using an exemplary embodiment.

Initially a process step of a batch process is selected as a test phase tp and at least one process step as a reference phase rf. A similarity between the test phase tp and at least one of the reference phases is then determined in pairs.

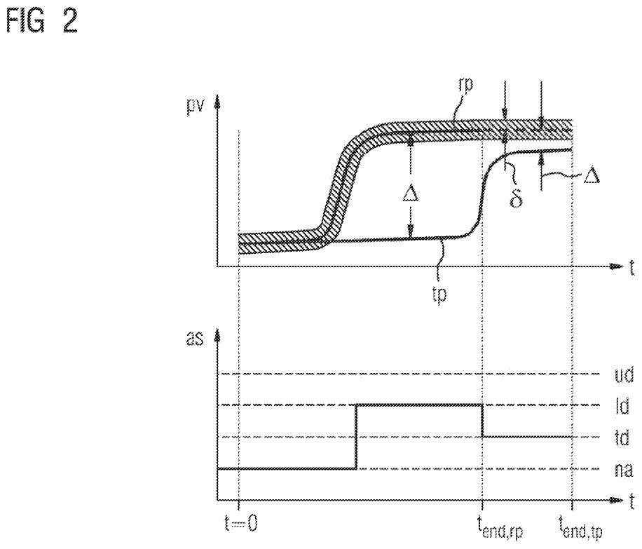

With a model, anomaly states as (see FIG. 2) of the test phase tp are determined with respect to each existing reference phase rp:

The determination of anomaly states of multivariant data frequently occurs via a data-based model for the detection of anomalies, as is known for example from EP 3 282 399 Bl. The identification of the process anomalies takes place there in a purely data-based manner via “self-organizing maps” (SOMs). The anomaly detection is not however restricted to this type of model. Another data-controlled model, such as a neural network or another machine-learning model, can also be used, where it should be emphasized that the model must be able to make its anomaly statement with respect to a reference phase and not generally with respect to a trained normal data distribution.

The model used should in principle represent a mapping of the process behavior. If the model is trained with historic “good data”, the latter represents the normal behavior of the process. Training is also possible with historic “bad data”, in order to map incorrect behavior of the process. This means that any process behavior can be represented on the basis of the historic data. The only prerequisite here is that the learning data is representative of all operating modes and events that occur in operation.

“Good data” can be determined by historic batch phases being checked by process experts or by analysis, e.g., of the laboratory values of the product of the batch process, in order to derive the conditions under which historic iterations of the phase can be regarded as good. The multivariate trend data of multiple iterations of the phase (cf. FIG. 1) is used to train the model to detect anomalies. This means in particular that the model knows the tolerance of the process based on the historic variations in the multivariate trend data.

The anomaly detection model thus requires the following input data: the multivariate trend data of a test batch phase (new data) and the multivariate trend data of at least one reference batch phase (historic data).

The corresponding phase pairs can in one embodiment be selected by a user or can be determined automatically using existing quality data. The test phase will generally be a phase of a current iteration, but it is also conceivable for any iteration of the corresponding phase to be used as a test phase. In the reference phase, a historic phase iteration is used as a further iteration. For each pair of iterations, the deviation between the process values of test and reference phase is determined for each time stamp of the test phase using the model for detecting anomalies and is weighted with an anomaly detection tolerance. The result corresponds to a weighted deviation between the process values of test and reference phase, which can be converted into preliminary anomaly states via threshold values. To suppress time fluctuations, filters can still be applied to the weighted deviation. Time deviations between the process values of test and reference phase are then analyzed. This finally results in a multivariate trend of anomaly states of the test phase in respect of the reference phase, which in turn is converted into the phase similarity measure.

A sample calculation is given below: in this case, the deviation Δ of the respective process value from the process value of the reference phase rp is calculated by the test phase tp for each time stamp ti (i=1 to N) of a sensor that records a process variable pv. Further, a weighted deviation Δ/δ is calculated, where δ corresponds to half the tolerance band (see FIG. 2). In the case of an asymmetrical tolerance band, the corresponding part of the tolerance band can also be selected. In FIG. 2, this would be the distance from rp to the lower edge of the tolerance band. If no deviation is present or if the deviation is within a tolerance band, then the anomaly state of the corresponding time stamp is evaluated with a similarity count or a degree of similarity of, for example, 1 and the anomaly state of this time stamp is given this value. If a deviation is present, then the anomaly state of the corresponding time stamp is, in this exemplary embodiment, evaluated with a degree of similarity of 0 and the anomaly state of this time stamp is given this value. By selecting the values 0 and 1, a standardization is automatically generated, which proves to be advantageous in order to create comparability.

The phase similarity measure for a process variable can then be calculated as a sum over the individually evaluated anomaly states of the individual time stamps of the test phase divided by the number of time stamps in the test phase. (The anomaly states can optionally also be used without evaluation). For multiple process variables, the cumulative measure is formed over all anomaly states of the process variables. The “overall” phase similarity measure can now, for example, be formed as a mean value of the similarity measures of the individual process variables. Alternatively, it is also conceivable for the worst similarity measure to be displayed as an “overall” phase similarity measure, so that the probability that the similarity between test and reference phase is better is certainly higher than this.

In this exemplary embodiment the anomaly states are weighted or categorized: the following categories are conceivable:
Upper deviation ud: for each time stamp the process value of the test phase is larger than the associated process value of the reference phase. In addition, the difference is greater than a particular tolerance that is defined by the trained model.
Lower deviation ld: for each time stamp the process value of the test phase is smaller than the associated process value of the reference phase. In addition, the difference is smaller than a particular tolerance that is defined by the trained model.
Time delay td: the test phase has a shorter or longer duration than the reference phase and exhibits a deviation with respect to the end time of the reference phase.

FIG. 2 uses two graphs to show a simplified example of the procedure for calculating the anomaly states. To this end, the trend of a test phase tp and the trend of a reference phase rp with its tolerance 25 are shown in the upper graph for a process variable pv and a selected process step. The start time of both phases is the same (t=0), while the end points of the test and reference phase (tend, rp and tend, tp) are different in time. The last valid value of the process variables of the reference phase is retained until the end time of the test phase, and the tolerance band is likewise continued. For this case, the anomaly state as is likewise plotted against the time t in the lower graph in FIG. 2. The lower graph shows the anomaly state as in a simplified manner for an individual process value pv plotted against the time. For each time stamp, the respective deviations A between the data records comprising the one process variable pv of the test phase tp and the data records comprising the one process variable pv of the reference phase rp are calculated and the result is assigned to the respective category. At the beginning, no anomaly is present or the deviation lies below a threshold value. These anomaly states are assigned to the category na. The anomaly states of the subsequent time stamps are assigned to the category ld, since for each time stamp the process value of the test phase is smaller than the associated process value of the reference phase. The anomaly states of the time stamps following this category are assigned to the category td, since differences exist between the duration of the test and reference phase here.

The fact that the anomaly states are categorical variables means it is possible to suppress short random deviations. For example, short peaks in the process values due to a network problem, which have no effect on the process (only an incorrect sensor measured value of the system, but not an incorrect process value at the physical installation). Other similarity measures such as the Euclidian distance or the Manhattan distance would react very sensitively to these short random peaks. The above-described approach is robust against these swings, because each time stamp has only a limited similarity value.

In addition, other evaluations can be assigned to the anomaly states, for example, that the duration of the test phase is shorter than expected or an evaluation for anomaly states in which the deviation is extremely large (outlier), or a weighting that takes into account the number of deviating process values per time stamp.

Further, individual weightings can be assigned to the individual categories of the anomaly states. Depending on what categories of the anomaly states exist, a hierarchy or a tree structure can be created in this way.

In a further exemplary embodiment, the anomaly states of all process variables of the test and reference phases are statistically evaluated together as a function of the time stamps and are analyzed and evaluated in accordance with a hierarchy. The phase similarity between the iterations of the test and reference phases can, for example, be calculated by a summand characterizing the hierarchy plus a scaling factor (this establishes the order inside a hierarchy level). If, for example, there are no sensor deviations (i.e. all anomaly states can be assigned to the category na in FIG. 2) or there are no time deviations between the data records of the process variables of the test and reference phase, then the phase similarity can be calculated by a value+(1−weighted deviation between test and reference phase averaged over all time stamps and process variables/maximum deviation)*0.1.

The following hierarchy for the phase similarity measures is conceivable:
No deviation->[0.9, 1.0]
Time deviation->[0.8, 0.9]
Time deviation with sensor deviation after end of the reference phase->[0.65, 0.8]
Sensor deviation->[0, 0.65]

Based on the evaluations of individual influencing variables, a phase similarity measure is thus determined, which is used for the optimization of the process. The phase similarity measure can in this case advantageously be standardized to values between zero and one for better comparability.

Valuable statistics can now be performed with the calculated phase similarity measures. As a function of the phase similarity measure, the reference phases with the greatest similarity to the test phase can, for example, be displayed. In this case, a ranking or sorting can occur. In combination with historic data records and metadata a cause analysis, e.g., of symptoms of an incorrect production process in batch processes, can be supported and accelerated via the calculated phase similarity measures.

In order to perform such a robust cause analysis, a wide variety of information in combination with the phase similarity measure can be displayed to an installation operator or a process engineer for a number of the most similar iterations. A software application, in which the inventive method is implemented, could for example be configured such that in a comparison the phase similarity measure (advantageously standardized to [0, 1]) of a test phase (here iteration 4) is displayed with the iterations of different reference phases (here iterations 1 to 3) from the history together with historic records and metadata of the respective reference phase:

| | Similarity measure | |
|---|---|---|
| | for iteration 4 | Historic records |
| Iteration 1 | 0.72 | Phase OK. |
| Iteration 2 | 0.98 | Valve V2 blocked, |
| | | needs cleaning |
| Iteration 3 | 0.66 | Phase OK. |

The information for the reference phase could, for example, also comprise, besides information about the quality of the iteration (phase “good”, “bad” or “average”), unique identifiers, precise start and end times of the historic iteration and metadata of the historic iteration. A quality statement of the reference iteration can be derived from the quality of the product, which was determined previously in the laboratory. Further, the metadata can contain records about failures in the corresponding iteration (e.g. blocked valve) or else initial approaches to solutions (e.g., valve cleaning necessary). Records of energy consumption, material consumption, material properties or other historical comments that have been made by installation operators or process engineers for the reference iteration in question are also conceivable.

The precise content of the metadata can further be configured for each specific application. Finally, it should be noted that the metadata may originate from different information sources and access thereto may occur either manually or automatically.

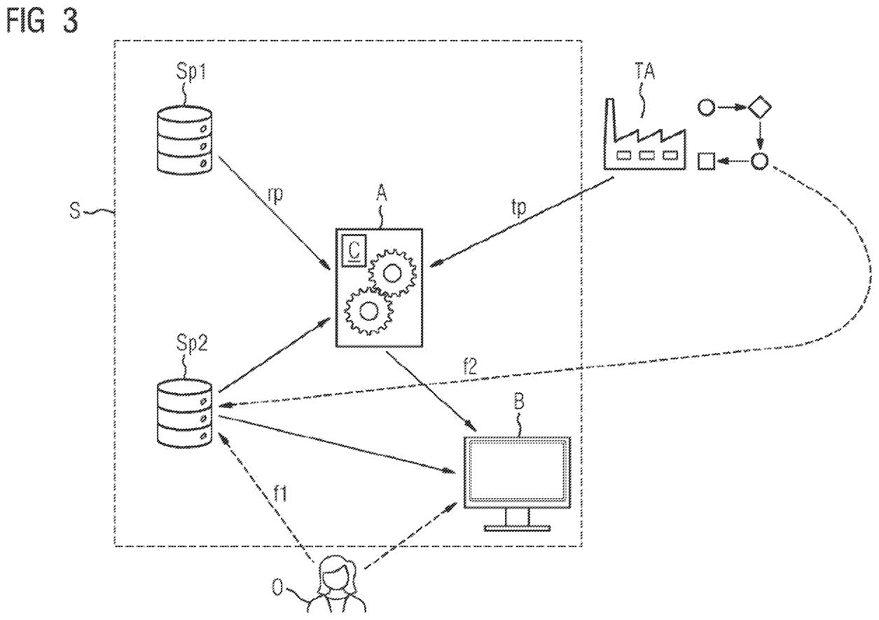

In this connection, reference is made to FIG. 3, which shows an exemplary embodiment of a system S that is configured to perform the inventive method. The system S in this exemplary embodiment comprises two units for storing data. Depending on the version, at least one data memory should be present. Data memory Sp1 in this exemplary embodiment contains a plurality of historic data records with the multivariant trends of the phase iterations. All historic data records, data records that contain values from a plurality of process variables with corresponding time stamps, can be used by the model to learn to determine anomalies. A separate unit L (not shown) for training the model to determine anomalies may also be present, which for this purpose uses the historic data records with time-dependent measured values of process variables and which for this is connected to the data memory Sp1. This unit L can advantageously be operated offline, because the training procedure is frequently compute-intensive, this primarily being the case when data records for many reference phases are present.

For the calculation of the phase similarity measure between a test phase tp and reference phase rp, which occurs here in the computing unit C (or processor), the computing unit C is connected to the memory unit Sp1. In a particularly advantageous embodiment, the computing unit C is part of an evaluation unit A. Different units A and C are each conceivable or just one unit in the form of a server, which combines all functions (the calculation and evaluation) in one application. The evaluation unit A and/or the computing unit C can further be connected to a control system of a technical installation TA or a computer of a technical sub-installation TA, in which a process-engineering process having at least one process step is running, via a communication interface, via which (e.g., on request) the multivariant data records of the test phase iterations are transmitted. In the technical installation TA, an automation system or a process control system controls, regulates and/or monitors a process-engineering process. To this end, the process control system is connected to a plurality of field devices (not shown). Measuring transducers and sensors serve to capture process variables, such as temperature T, pressure P, flow rate F, level L, density or gas concentration of a medium.

The phase similarities and further analysis results determined via the evaluation unit A are output in the exemplary embodiment outlined in FIG. 3 on the user interface of a display unit B for visualization. The display unit B can also be linked directly to the system or, depending on the implementation, can be connected to the system via a data bus for example. In a particularly advantageous embodiment, the phase similarity measures are displayed on the user interface in conjunction with metadata. To this end, the display unit B is connected to the memory unit Sp2, in which the metadata of the reference phases or of the historic iterations of the phases is stored. Also conceivable is a communication connection between the evaluation unit A and/or the calculation unit C, in order to calculate correlations between the metadata and the phase similarity measure.

In one exemplary embodiment, the reference phases with the greatest match with the test phases are displayed on the user interface of the operating unit. In addition, the associated metadata of the reference phases is displayed. At this point, a system user or operator O or a process expert can check the result and determine the cause of problem. The dashed lines f1 and f2 show feedback to the metadata memory, which is retrieved either automatically from available data sources, such as the control system of the technical installation TA, or is generated by comments by the system user O. Thus, it is possible for a system user O to enter comments or metadata records in an input field of the user interface during the cause analysis for the test phase currently being analyzed. Because this metadata is stored, the system becomes smarter over time and can be regarded as a self-learning system.

In a further advantageous embodiment of the invention, a configurable selection of the time profiles of the process variables and/or anomaly states of the test and reference phase are simultaneously shown on a display unit and/or in correlation with one another as time profiles. Monitoring the process-engineering process is in this way made easier for an installation operator or the operator of an inventive software application. In order to be able to work efficiently on troubleshooting with the results shown, a configurable selection of the results is particularly advantageous. Owing to an appropriate display, installation operators can act fast in critical situations and avoid an error. Fast interaction can save both money and time and can also avert more serious hazards.

The system S for the performance of the inventive method can, for example, also be implemented in a client-server architecture. The server with its data memories here serves to provide certain services, such as the inventive system, for processing a precisely defined task (here the calculation of the phase similarity measure). The client (here the display unit B) can request the corresponding services from the server and use them. Typical servers are web servers for the provision of the contents of websites, database servers for storing data or application servers for the provision of programs. The interaction between the server and client occurs via suitable communication protocols such as http or jdbc. A further possibility is the use of the method as an application in a cloud environment (e.g., Siemens MindSphere), where one or more servers host the inventive system in the cloud. Alternatively, the system can be implemented as an on-premise solution directly on the technical installation, so that a local connection to databases and computers at control system level is possible.

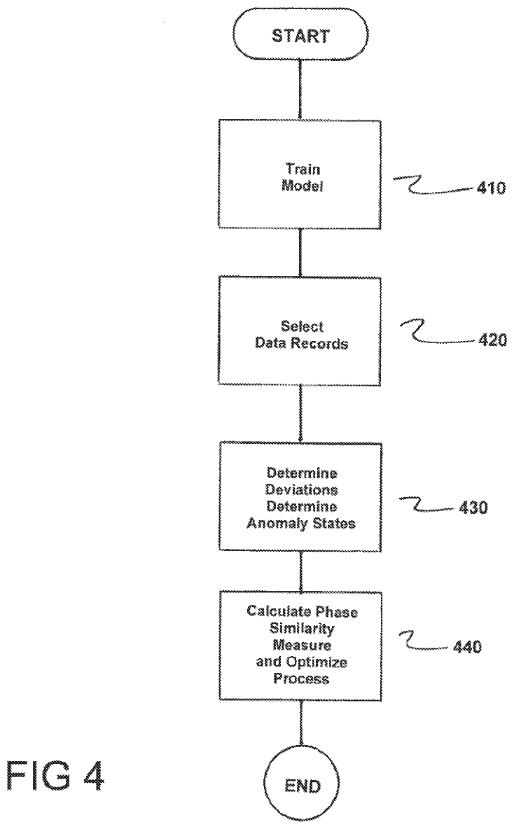

FIG. 4 is a flowchart of a method for improving a production process in a technical installation in which a process engineering process having at least one process step is implemented, where data records characterizing an iteration PR1, PR2 of a process step and containing values of process variables pv1, pv2, . . . , pvn are captured on a time-dependent basis t0, t1, . . . , tN and stored in a data memory.

The method comprises utilizing multivariate trend data of multiple iterations of a process step to train a model to detect anomalies, as indicated in step 410.

Next, for each process step, the data records of an iteration PR1 are selected as a test phase tp and the data records of at least one further iteration PR2 are selected as a reference phase rp, as indicated in step 420.

Next, a model for detecting anomalies is used to determine, for each pair of iterations, a deviation between process values of test and reference phase for each time stamp of the test phase and the deviation is weighted with an anomaly detection tolerance, as indicated in step 430.

Next, anomaly states are determined from weighted deviations between the process values of test and reference phase and the determined anomaly states are evaluated, as indicated in step 440.

Next, a phase similarity measure of the test phase compared to a reference phase is calculated via the evaluated anomaly states and the calculated phase similarity measure is used to analyze and subsequently optimize the process, as indicated in step 450.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A method for improving a production process in a technical installation in which a process-engineering process having at least one process step is implemented, data records characterizing an iteration of a process step and containing values of process variables being captured on a time-dependent basis and stored in a data memory, the method comprising:
utilizing multivariate trend data of multiple iterations of a process step to train a model to detect anomalies;
selecting, for each process step, the data records of an iteration as a test phase and the data records of at least one further iteration as a reference phase;
determining, for each pair of iterations, a deviation between process values of test and reference phase for each time stamp of the test phase utilizing a model for detecting anomalies and weighting the deviation with an anomaly detection tolerance;
determining anomaly states from weighted deviations between the process values of test and reference phase and evaluating the determined anomaly states; and
calculating a phase similarity measure of the test phase compared to a reference phase via the evaluated anomaly states and utilizing the calculated phase similarity measure to analyze and subsequently optimize the process.

13. The method as claimed in claim 12, wherein metadata of the reference phases is taken into account when optimizing the process; and
wherein a correlation is created between the phase similarity measure of the test and reference phase with the metadata of the reference phases and, based on this correlation, at least one of statements about the test phase are determined and a cause analysis occurs using the metadata of the reference phases.

14. The method as claimed in claim 12, wherein the anomaly states are calculated; and wherein for each process step for the same process variables of the test and reference phase time stamp by time stamp, at least one of (i) a size of the differences or mathematical distances of values of the process variables, (ii) their tolerances and (iii) a difference in runtimes of the phases is determined.

15. The method as claimed in claim 13, wherein the anomaly states are calculated; and wherein for each process step for the same process variables of the test and reference phase time stamp by time stamp, at least one of (i) a size of the differences or mathematical distances of values of the process variables, (ii) their tolerances and (iii) a difference in runtimes of the phases is determined.

16. The method as claimed in claim 12, wherein the anomaly states are evaluated via at least one of weightings, averaging and categories.

17. The method as claimed in claim 13, wherein the anomaly states are evaluated via at least one of weightings, averaging and categories.

18. The method as claimed in claim 14, wherein the anomaly states are evaluated via at least one of weightings, averaging and categories.

19. The method as claimed in claim 12, wherein the evaluation of the anomaly states follows a previously defined hierarchy.

20. The method as claimed in claim 13, wherein the evaluation of the anomaly states follows a previously defined hierarchy.

21. The method as claimed in claim 14, wherein the evaluation of the anomaly states follows a previously defined hierarchy.

22. The method as claimed in claim 12, wherein similar phases are grouped based on the calculated phase similarity measure and a cause analysis is performed for the grouping via the metadata.

23. The method as claimed in claim 12, wherein a ranking of the phase similarity measure is performed and phases with the greatest match between test and reference phases are displayed.

24. A system for improving a production process of a technical installation in which a process-engineering process having at least one process step is implemented, the system comprising at least:
a memory unit for at least one of (i) storing historic data records with values of process variables determined on a time-dependent basis, which characterize an iteration of a process step (phase), (ii) storing metadata which is associated with the historic data records and (iii) storing at least one of tolerances, anomaly states, phase similarities and further data;
a computing unit which is connected to the at least one memory unit,
a evaluation unit for analyzing current data records of an iteration of a test phase via the computing unit; and
a display unit for displaying and outputting the analysis results determined via the evaluation unit.

25. A computer program comprising a software application including program code instructions which are executable by a computer to implement the method as claimed in claim 12, when the computer program is executed on a computer.

26. A non-transitory computer-readable storage medium encoded with a computer program which, when executed by a processor of a computer, causes a production process in a technical installation in which a process-engineering process having at least one process step is implemented to be improved, data records characterizing an iteration of a process step and containing values of process variables being captured on a time-dependent basis and stored in a data memory, the computer program comprising:
program code for utilizing multivariate trend data of multiple iterations of a process step to train a model to detect anomalies;
program code for selecting, for each process step, the data records of an iteration as a test phase and the data records of at least one further iteration as a reference phase;
program code for determining, for each pair of iterations, a deviation between process values of test and reference phase for each time stamp of the test phase utilizing a model for detecting anomalies and weighting the deviation with an anomaly detection tolerance;
program code for determining anomaly states from weighted deviations between the process values of test and reference phase and evaluating the determined anomaly states; and
program code for calculating a phase similarity measure of the test phase compared to a reference phase via the evaluated anomaly states and utilizing the calculated phase similarity measure to analyze and subsequently optimize the process.
